(19) United States
(12) Patent Application Publication
(10) Pub. No.: US 2019/0032359 A1
(43) Pub. Date: Jan. 31, 2019

(54) SOLAR UMBRELLA

(71) Applicant: BEIJING APOLLO DING RONG SOLAR TECHNOLOGY CO., LTD., Beijing (CN)

(72) Inventors: Bo JIANG, Beijing (CN); Yanpeng JU, Beijing (CN); Xun ZHAO, Beijing (CN)

(21) Appl. No.: 16/145,816

(22) Filed: Sep. 28, 2018

Related U.S. Application Data
(63) Continuation-in-part of application No. PCT/CN2017/077804, filed on Mar. 23, 2017.

(30) Foreign Application Priority Data
Mar. 29, 2016 (CN) 201620251015.X

(51) Int. Cl. E04H 15/02; E04H 15/28; A45B 23/00; H02S 20/30

(52) U.S. Cl. CPC E04H 15/02; E04H 15/28; A45B 2023/0006; H02S 20/30; A45B 23/00

(57) ABSTRACT

Provided is a solar umbrella. The solar umbrella includes: solar cells packaged on umbrella cloth; umbrella ribs configured for supporting the umbrella cloth; a line concentration device mounted on the umbrella ribs. The line concentration device has sockets. The solar cells are connected to the sockets of the line concentration device.

### CROSS REFERENCE TO RELATED APPLICATIONS

The present application is a continuation-in-part application of International patent application number PCT/CN2017/077804, filed on Mar. 23, 2017, published as WO 2017/167108 A1, entitled “Solar Umbrella”, which claims benefit/priority of Chinese patent application with the application number 201620251015.X filed on Mar. 29, 2016, published as CN205456651A, entitled “Solar Umbrella”, the contents of all of which are incorporated herein by reference in their entirety.

### BACKGROUND

### Technical Field

The present disclosure relates to the field of umbrellas, and particularly to a solar umbrella.

### Background Art

With the development of solar power technology, more and more articles in life start to be equipped with a solar power generating device for heat supply. In recent years, more and more umbrellas for keeping out of sun and rain have a function of solar power generation.

Solar cells generally include rigid monocrystalline silicon solar cell and flexible amorphous silicon solar cell. Although flexible solar cells have certain flexibility, such flexible solar cells would still be damaged in use of the umbrella. This problem is more prominent for rigid solar cell.

Inventors found in researches that the prior art has following defects: a conducting line of the solar cell is easily damaged, moreover, the damage to a single solar cell or the conducting line thereof may affect the power generation of other solar cells.

### SUMMARY

An embodiment of the present disclosure provides a solar umbrella. The solar umbrella includes umbrella cloth, an umbrella rod, an umbrella base, an auxiliary umbrella, umbrella ribs, solar cells, a storage battery and a line concentration device. The solar cells which are packaged are provided on the umbrella cloth. The umbrella cloth is supported by the umbrella ribs. The umbrella rod connects the umbrella ribs and the umbrella base. The line concentration device is mounted on the umbrella ribs. The line concentration device has multiple sockets. The solar cells are connected to the sockets of the line concentration device. The auxiliary umbrella is disposed above the umbrella cloth and covers the sockets. The storage battery is located inside the umbrella rod and connected with the line concentration device.

An embodiment of the present disclosure further provides a solar umbrella. The solar umbrella includes: a solar cell packaged on umbrella cloth; umbrella ribs configured for supporting the umbrella cloth; a line concentration device mounted on the umbrella ribs. The line concentration device has sockets. The solar cells are connected to the sockets of the line concentration device.

An embodiment of the present disclosure further provides a solar umbrella. The solar umbrella includes umbrella ribs and solar cells. Each of the umbrella ribs includes a skeleton and a slide rail mounted on the skeleton. The slide rail is provided with a slide groove, and the slide groove is configured for receiving a solar cell.

### BRIEF DESCRIPTION OF DRAWINGS

FIG. 1 is a front view of a solar umbrella according to an embodiment of the present disclosure;

FIG. 2 is a front view of the solar umbrella, with an umbrella cloth and an auxiliary umbrella being removed, according to an embodiment of the present disclosure;

FIG. 3 is an exploded view of a solar umbrella top portion according to an embodiment of the present disclosure;

FIG. 4 is an exploded view of a line concentration device in the solar umbrella top portion according to an embodiment of the present disclosure;

FIG. 5 is a partial enlarged view of the line concentration device of the solar umbrella according to an embodiment of the present disclosure;

FIG. 6 is an exploded view of a control device of the solar umbrella according to an embodiment of the present disclosure;

FIG. 7 is a front view of a touch panel of the control device of the solar umbrella according to an embodiment of the present disclosure;

FIG. 8 is an exploded view of an umbrella base and an umbrella rod of the solar umbrella according to an embodiment of the present disclosure;

FIG. 9 is an exploded view of the umbrella base of the solar umbrella according to an embodiment of the present disclosure;

FIG. 10 is a perspective view of a storage battery of the solar umbrella according to an embodiment of the present disclosure;

FIG. 11 is a perspective view of the solar umbrella according to an embodiment of the present disclosure;

FIG. 12 is a perspective view of another solar umbrella, from another angle, according to an embodiment of the present disclosure;

FIG. 13 is a perspective view of an umbrella rib according to an embodiment of the present disclosure;

FIG. 14 is a perspective view of the umbrella rib, from another angle, according to an embodiment of the present disclosure;

FIG. 15 is a perspective view of a slide rail according to an embodiment of the present disclosure;

FIG. 16 is a perspective view of a skeleton according to an embodiment of the present disclosure;

FIG. 17 is a perspective view of a first blanking cap according to an embodiment of the present disclosure;

FIG. 18 is a perspective view of the first blanking cap, from another angle, according to an embodiment of the present disclosure;

FIG. 19 is a perspective view of a second blanking cap according to an embodiment of the present disclosure;

FIG. 20 is a perspective view of a third blanking cap according to an embodiment of the present disclosure;

FIG. 21 is a perspective view of the umbrella cloth according to an embodiment of the present disclosure;

FIG. 22 is a perspective view of the umbrella cloth, in a mounting structure, according to an embodiment of the present disclosure;

FIG. 23 is a partial enlarged view of portion A in FIG. 22;

FIG. 24 is a perspective view of the umbrella rib, with the solar cells mounted thereon, according to an embodiment of the present disclosure;

FIG. 25 is a schematic diagram of a control circuit of the solar umbrella according to an embodiment of the present disclosure;

FIG. 26 is a schematic diagram of a power supply circuit of the storage battery according to an embodiment of the present disclosure.

Reference signs: 1—umbrella cloth, 2—umbrella rod, 3—umbrella base, 4—auxiliary umbrella, 5—line concentration device, 6—control device, 7—fastening device, 8—storage battery, 9—umbrella rib, 101—solar cell, 110—support rod, 201—first hole, 301—base upright column, 302—base main body, 303—base fastening device, 304—base fastening screw, 501—top cover of the line concentration device, 502—line concentrator fastener, 503—line concentrator, 504—line concentration device base, 505—socket, 506—recess, 601—control device rear cover, 602—control device front cover, 603—control device rear cover fixing bolt, 604—USB interface, 801—battery cell, 802—fixing plate, 803—second hole, 804—battery top cover, 805—battery base, 806—third hole, 807—positioning groove, 901—LED lamp, 910—slide rail, 911—bottom wall, 912—upper wall, 913—gap, 914—slide groove, 915—auxiliary slide rail, 916—first slot, 917—connecting rib, 918—clamping portion, 919—second slot, 9110—communicating hole, 920—skeleton, 921—tubular portion, 922—clamping groove, 923—third slot, 924—notch, 930—first blanking cap, 931—first arm portion, 932—first tube portion, 933—second tube portion, 934—blocking portion, 935—first plate portion, 936—first bolt hole, 940—second blanking cap, 941—second arm portion, 942—fourth tube portion, 943—second plate portion, 944—second bolt hole, 950—third blanking cap, 951—third tube portion, 952—stop portion, 1001—touch panel; 1002—bluetooth module; 1003—motor; 1004—MPPT controller; 1005—MCU; 1006—control system; 1007—WIFI module; 1008—network card interface.

### DETAILED DESCRIPTION OF EMBODIMENTS

In the following description, “up” and “down” are respectively pointed to a sky direction and a ground direction, “distal” and “proximal” refer to directions relative to an umbrella rod 2, that is, an end away from the umbrella rod 2 is a distal end, and such distal end is usually at an edge of the umbrella, and an end close to the umbrella rod 2 is a proximal end.

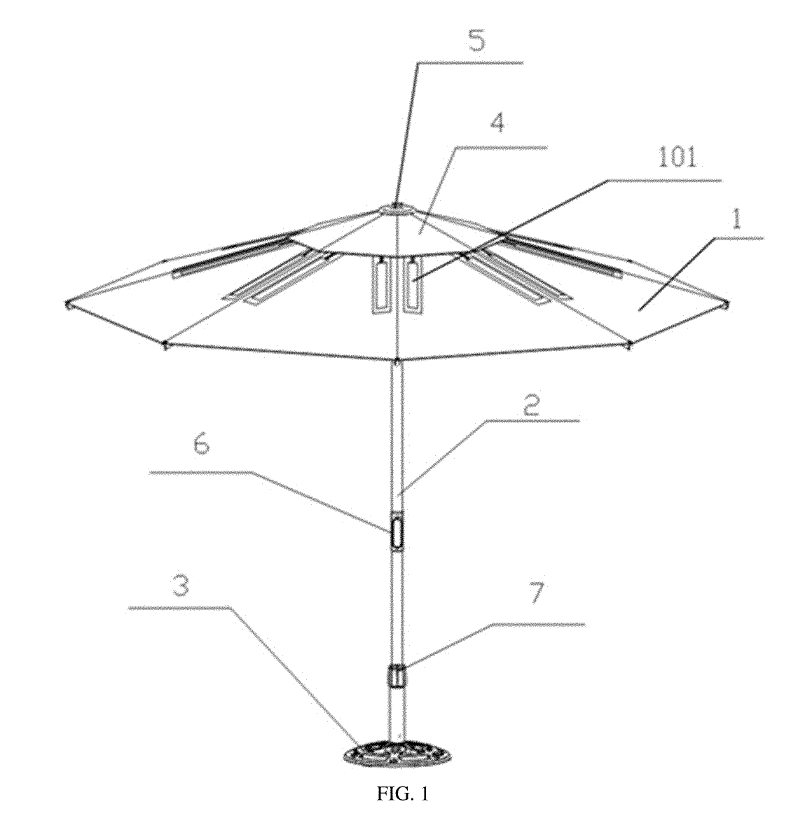

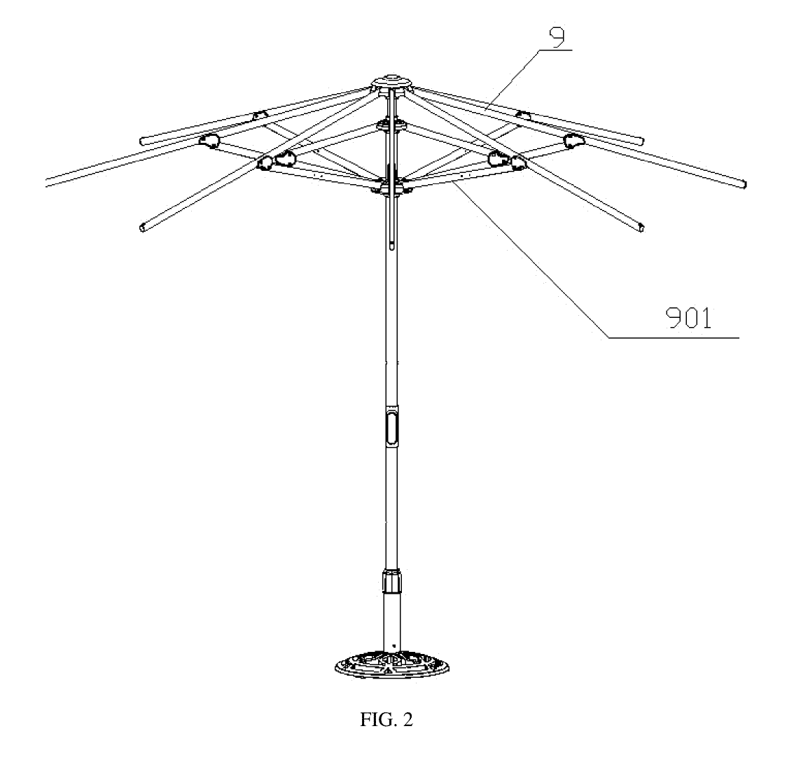

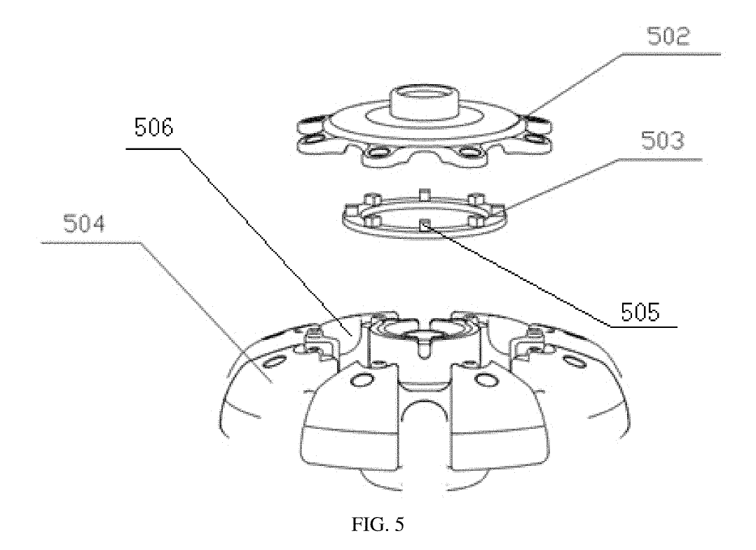

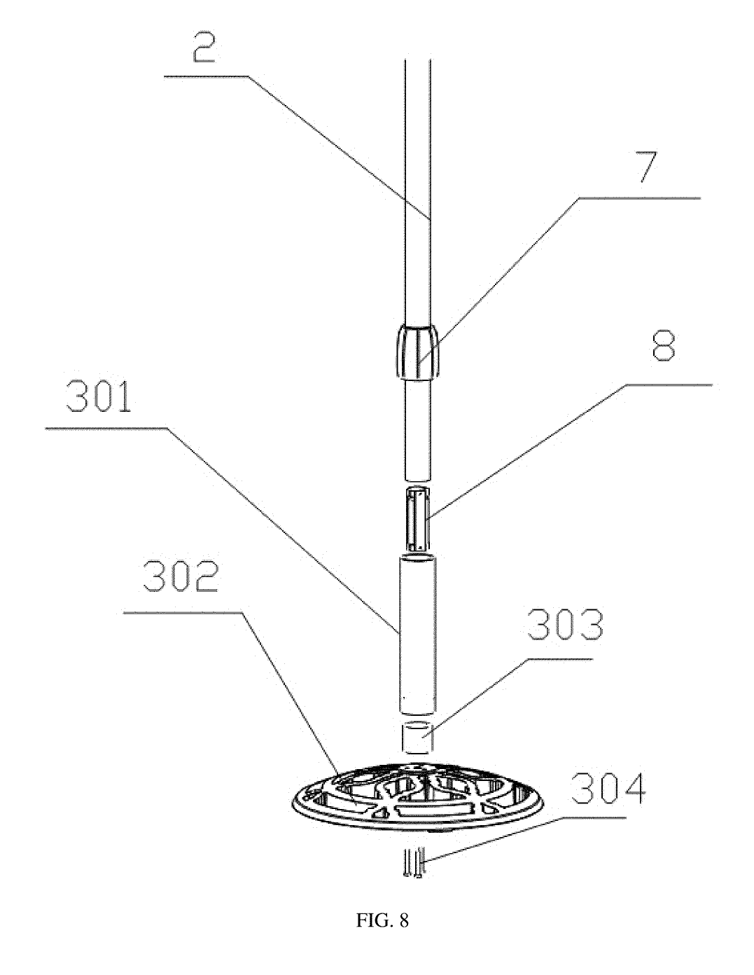

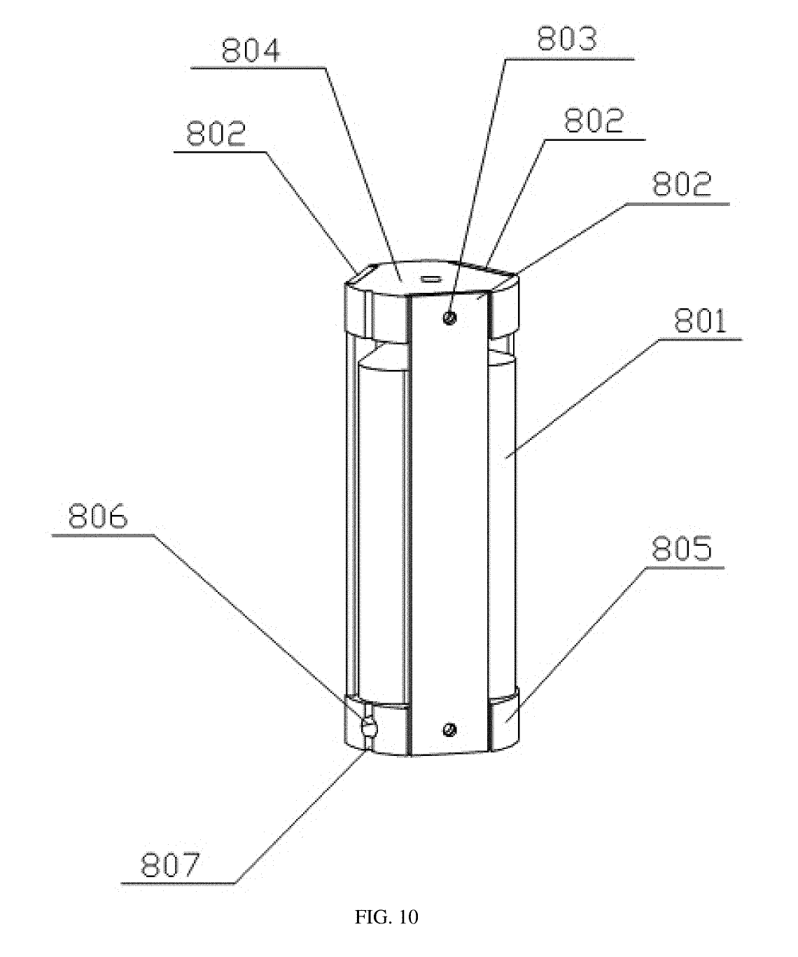

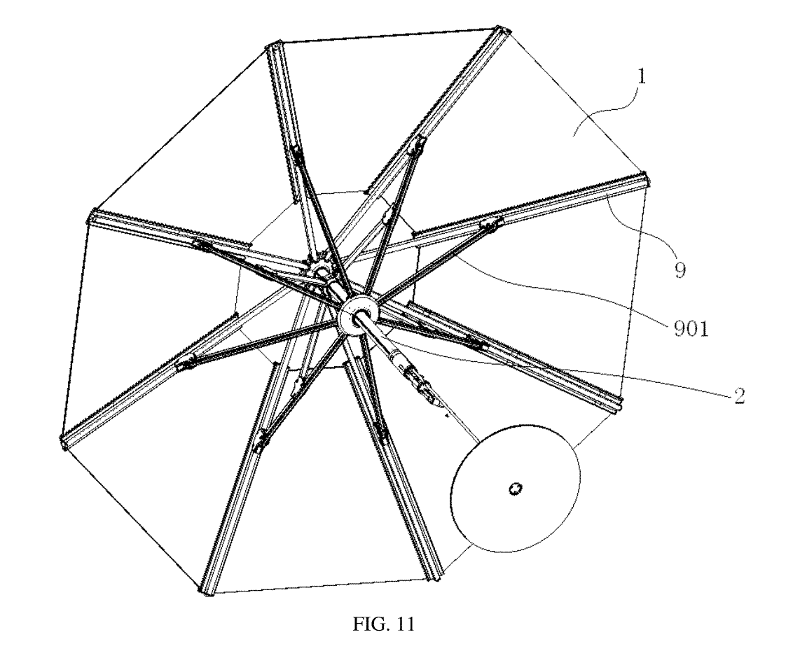

Referring to FIG. 1 and FIG. 2, a solar umbrella is provided by the present embodiment. The solar umbrella includes: umbrella cloth 1, an umbrella rod 2, an umbrella base 3, an auxiliary umbrella 4, a line concentration device 5, a control device 6, a fastening device 7, a storage battery 8 (see FIG. 8 and FIG. 10), umbrella ribs 9, solar cells 101 and so on. The solar cells are directly or indirectly packaged on the umbrella cloth 1, and the solar cells 101 are connected in series or in parallel according to requirements of a current and a voltage. A circuit of each solar cell 101 is provided with a diode, so as to ensure that an individual solar cell 101, after being damaged, does not affect an operation of the whole circuit. The umbrella cloth 1 is supported by the umbrella ribs 9. The umbrella rod 2 connects the umbrella ribs 9 and the umbrella base 3. LED lamps 901 are mounted on the umbrella ribs 9. The umbrella rod 2 is provided thereon with electrically conductive contacts, and the LED lamps 901 are connected with the electrically conductive contacts after the umbrella ribs 9 are unfolded, so as to realize an illumination of the LED lamps 901. The line concentration device 5 is mounted on the umbrella rib 9. The line concentration device 5 has multiple sockets 505 (see FIG. 5). The solar cells 101 are connected to the sockets 505 of the line concentration device 5. The auxiliary umbrella 4 is disposed above the umbrella cloth 1 and covers the sockets 505. The storage battery 8 is located inside the umbrella rod 2 and connected with the line concentration device 5.

In the present embodiment, various solar cells 101 are connected to the multiple sockets 505 on the line concentration device 5. Currents generated by various solar cells 101, after being converged by the line concentration device 5, enter the storage battery 8, the line concentration device 5 can function to protect the conducting lines of the solar cells 101. The conducting lines of the solar cells 101 are inserted separately, without affecting each other, and thus the damage to a single solar cell 101 or the conducting line thereof will not affect the operation of other solar cells 101. The plug connection is flexible, and easy for maintenance. In such manner, reliability, maintenance convenience, and service life of the solar umbrella can be improved.

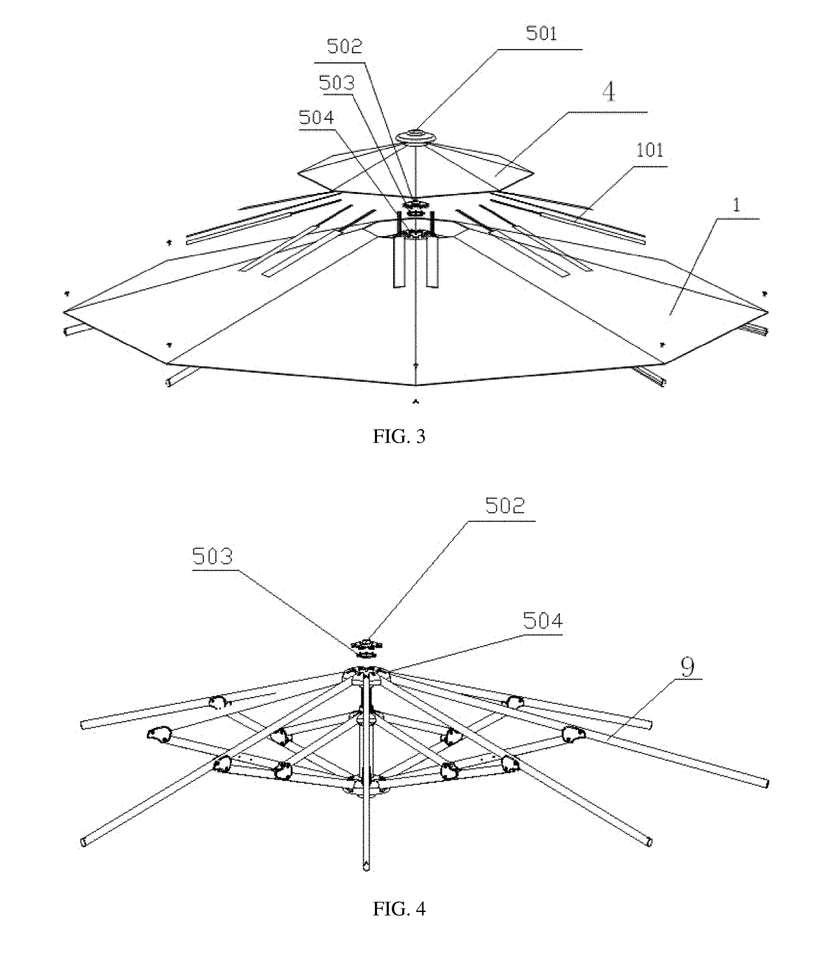

Referring to FIGS. 3, 4 and 5, the line concentration device 5 is mounted on the umbrella ribs 9. More specifically, the line concentration device 5 includes a top cover 501 of the line concentration device, a line concentrator fastener 502, a line concentrator 503 and a line concentration device base 504. The line concentration device base 504 is mounted on the umbrella ribs 9, and the line concentration device base 504 is provided thereon with a recess 506. The line concentrator 503 is placed inside the recess 506, and the line concentrator fastener 502 is fastened through a bolt onto the line concentration device base 504, so as to hold the line concentrator 503 within the recess 506. The line concentrator 503 is electrically connected with the storage battery 8. The structure of the line concentration device 5 can provide sufficient anti-collision and rain-proof protection for the line concentrator 503 which acts as a main converging part. In addition, the line concentrator 503 has multiple sockets 505, a conducting line of each solar cell 101 is connected to one socket 505, so as to realize a concentration of currents from the solar cells 101 to the storage battery 8. The top cover 501 of the line concentration device is located above the auxiliary umbrella 4, and the top cover 501 of the line concentration device is connected through a bolt with the line concentrator fastener 502, such that the auxiliary umbrella 4 is clamped by the top cover of the line concentration device and the line concentrator fastener, which ensures that the auxiliary umbrella 4 is disposed above the umbrella cloth 1 and covers the sockets 505, thereby serving an anti-collision, water-proof and dust-proof protective function to the sockets 505.

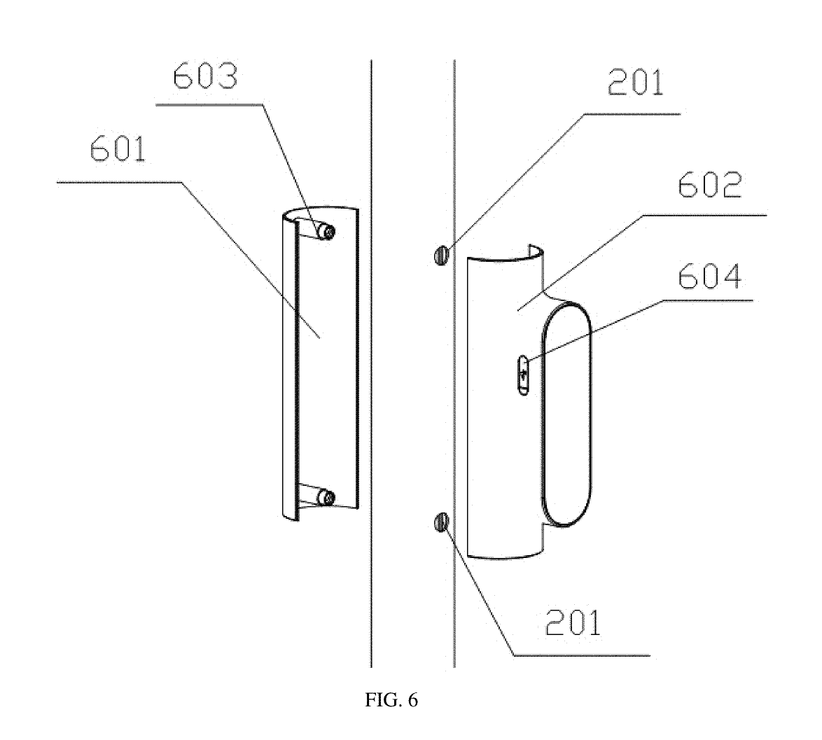

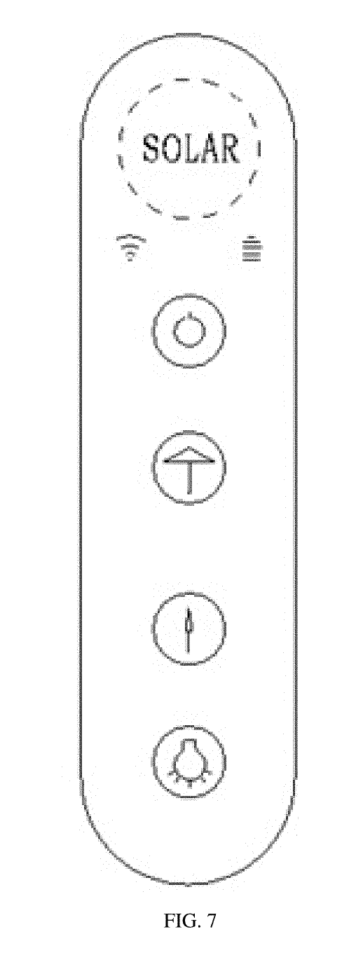

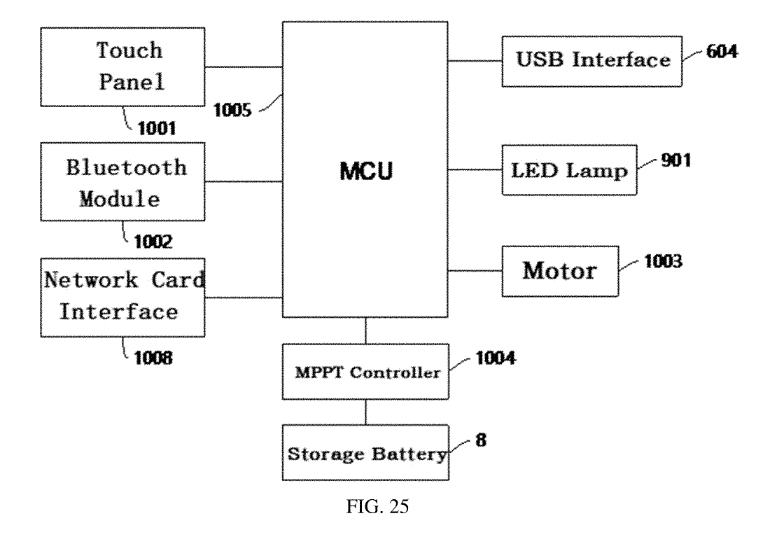

Referring to FIG. 6, the solar umbrella further includes the control device 6 mounted on the umbrella rod 2. Specifically, this figure shows a connection structure of the umbrella rod 2 and the control device 6 in detail. The control device 6 includes a control device rear cover 601 and a control device front cover 602. The control device rear cover 601 is provided thereon with a control device rear cover fixing bolt 603. The control device rear cover fixing bolt 603 is configured for passing through a first hole 201 on the umbrella rod 2 and then cooperates with the control device front cover 602 to fix the control device 6 on the umbrella rod 2. Two sides of the control device front cover 602 are symmetrically provided with USB interfaces 604. External electric equipment can be conveniently supplied with power through the USB interface 604, specifically, the solar energies stored by the storage battery 8 inside the umbrella rod 2 can be supplied to external equipment, and the external electric equipment can also be directly supplied with power through the solar cells 101. The control device 6 is further provided therein with a bluetooth module 1002 and a network card interface 1008 (see FIG. 25), which can provide a WIFI signal and can be manipulated through a mobile phone APP. Alternatively, The control device 6 may be further provided with a charging interface configured for supplying power to the storage battery 8 using mains supply. In cases where there is no sunlight, the storage battery 8 can be charged through the charging interface. In the present embodiment, opening and closing of the umbrella ribs 9 are driven by a motor, and the storage battery 8 supplies power to the motor under control of the control device 6. A WIFI module can be mounted inside the control device 6. A remote controller controls the motor remotely to drive the folding or opening of the solar umbrella, control WIFI, control power-on and power-off of the LED lamps 901 and so on. The remote controller may be a mobile phone, and the control functions may be realized specifically by downloading an app.

Referring to FIG. 7, the control device 6 has a touch panel. The touch panel is provided thereon with a power switch, a button for opening the umbrella, a button for closing the umbrella and a button for turning on and off the LED lamp, and all of the buttons are in a touch mode. It should be indicated that the LED lamps 901 mounted on the umbrella ribs 9 are controlled by the button of the LED lamps, the opening and closing of the umbrella ribs 9 are driven by the motor, the driving of the motor is controlled by the button for opening the umbrella and the button for closing the umbrella, and the storage battery 8 supplies power to the LED lamps 901 and the motor through the control device 6.

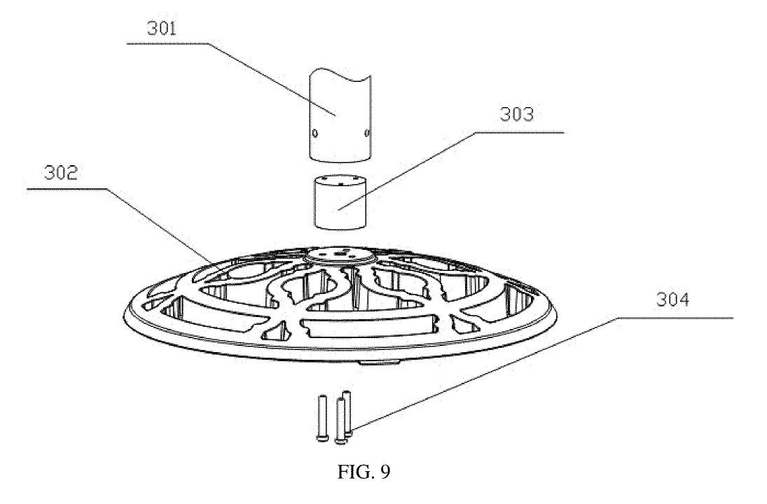

Referring to FIGS. 8 and 9, the umbrella base 3 includes a base upright column 301, a base main body 302 and a base fastening device 303. The umbrella rod 2 is inserted into and detachably connected with the base upright column 301, and the umbrella rod and the base upright column are tightened and fixed through a fastening device 7, for example, a threaded pipe. The storage battery 8 is kept inside the umbrella rod 2. The storage battery 8 is connected with the line concentration device 5 through the conducting lines inside the umbrella rod 2. The base upright column 301 is connected with the base main body 302 through the base fastening device 303, and is tightened and fixed through the base fastening screws 304.

Of course, it is also feasible that bottom of the base upright column 301 is provided with a threaded hole, and the base main body 302 is also provided with a threaded hole. The base fastening screws 304, after passing through the threaded hole in the base main body 302 and the threaded hole in the base upright column 301, fix the base upright column 301 onto the base main body 302. Alternatively, the base upright column 301 and the base main body 302 are molded and manufactured in one piece. Referring to FIG. 10, the storage battery 8 includes a battery cell 801, a fixing plate 802, a battery top cover 804 and a battery base 805. The battery cells 801 are placed between the battery top cover 804 and the battery base 805, and held by the fixing plate 802. A positioning groove 807 is provided on the battery base 805, and a third hole 806 is provided at the positioning groove 807. A protrusion corresponding to the positioning groove 807 is provided within the umbrella rod, and in mounting, the positioning groove 807 of the storage battery 8 correspondingly cooperates with the protrusion inside the umbrella rod 2, such that the storage battery 8 is enabled to slide into the umbrella rod 2. A bolt passes through the umbrella rod 2 and then is screwed in the third hole 806 at the positioning groove 807, so as to fix the storage battery 8. The structure of the storage battery 8 facilitates positioning of each battery cell 801 inside the umbrella rod 2.

Meanwhile, each of two ends of the fixing plate 802 is provided with one second hole 803, and two ends of the fixing plate 802 can be respectively fixed on the battery top cover 804 and the battery base 805 by two bolts passing through the two second holes 803.

It should be indicated that in specific implementation, the number of the battery cells 801 may also be merely one.

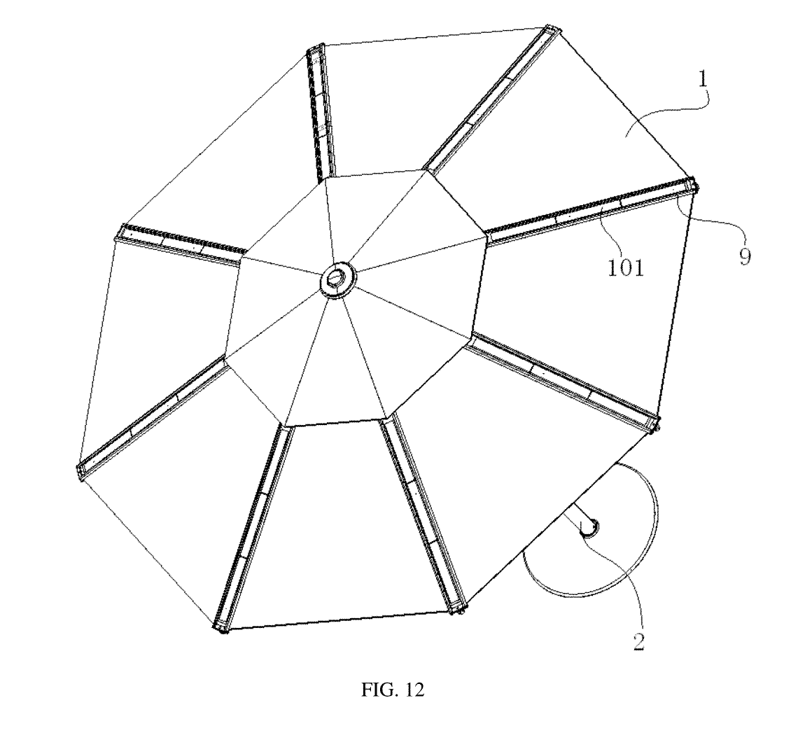

Referring to FIG. 11 and FIG. 12, FIG. 11 and FIG. 12 show another solar umbrella according to the present embodiment. FIG. 11 is a view obtained by observing the solar umbrella obliquely from below. The umbrella ribs 9, the umbrella cloth 1, the umbrella rod 2 and so on of the solar umbrella can be seen in this figure.

Referring to FIG. 12, FIG. 12 is a view obtained by observing the solar umbrella obliquely from above. The solar umbrella further includes the solar cells 101. Different from the structure of the solar umbrella mentioned above, the solar cells 101 shown in FIG. 12 are not directly supported by the umbrella cloth 1, but supported by the umbrella ribs 9. Therefore, in the present embodiment, the solar cells 101 can be regarded as being indirectly packaged on the umbrella cloth 1, and advantages of the indirect packaging will be described in the following. In practical manufacture, the solar cells 101 may also be directly packaged with the umbrella cloth 1 by adopting manners in the prior art such as stitching and pasting.

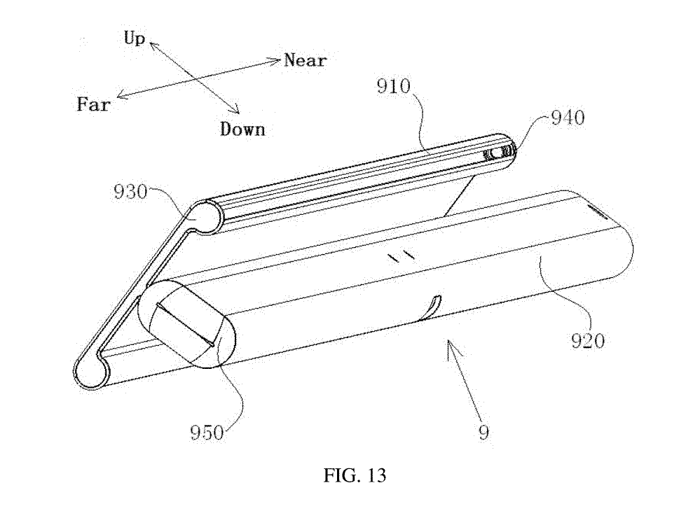

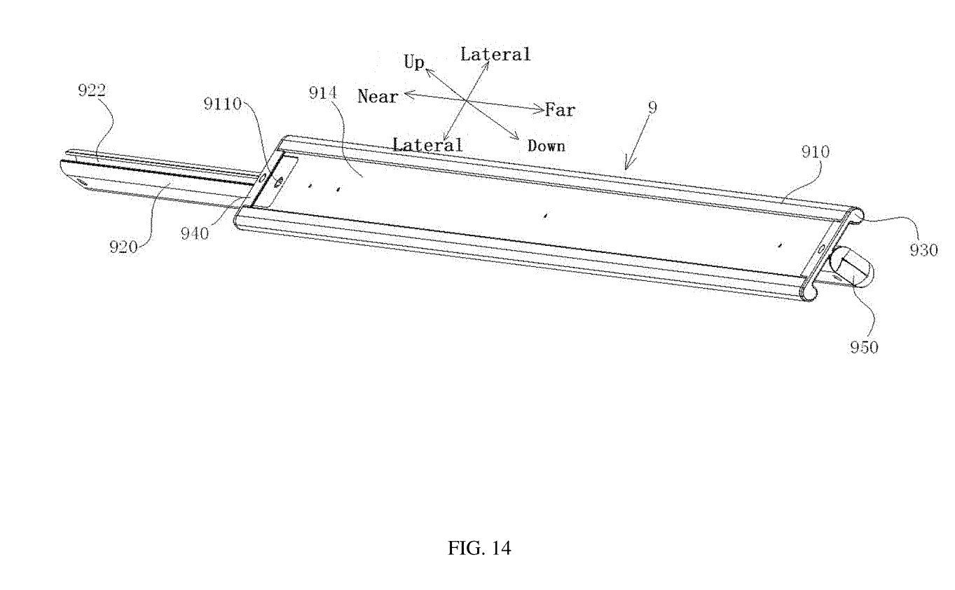

Referring to FIGS. 13 and 14, each of the umbrella ribs 9 includes a skeleton 920, a slide rail 910 mounted on the skeleton 920, a first blanking cap 930, a second blanking cap 940 and a third blanking cap 950. Although the first blanking cap 930 and the third blanking cap 950 are in separated structures in an embodiment described below, in practical application, the first blanking cap 930 and the third blanking cap 950 may also be in a one-piece structure. Similarly, the slide rail 910 and the skeleton 920 are in separated structures in the embodiment described below, but in practical application, the slide rail and the skeleton may also be in a one-piece structure, and the one-piece structure still falls within the scope of “mounting” referred to in embodiments of the present disclosure, and thus will not be distinguished again. In a direction from far to near, a length of the slide rail 910 is smaller than a length of the skeleton 920. Therefore, a part of the skeleton 920 is covered by the slide rail 910, and the other part of the skeleton is not covered by the slide rail 910.

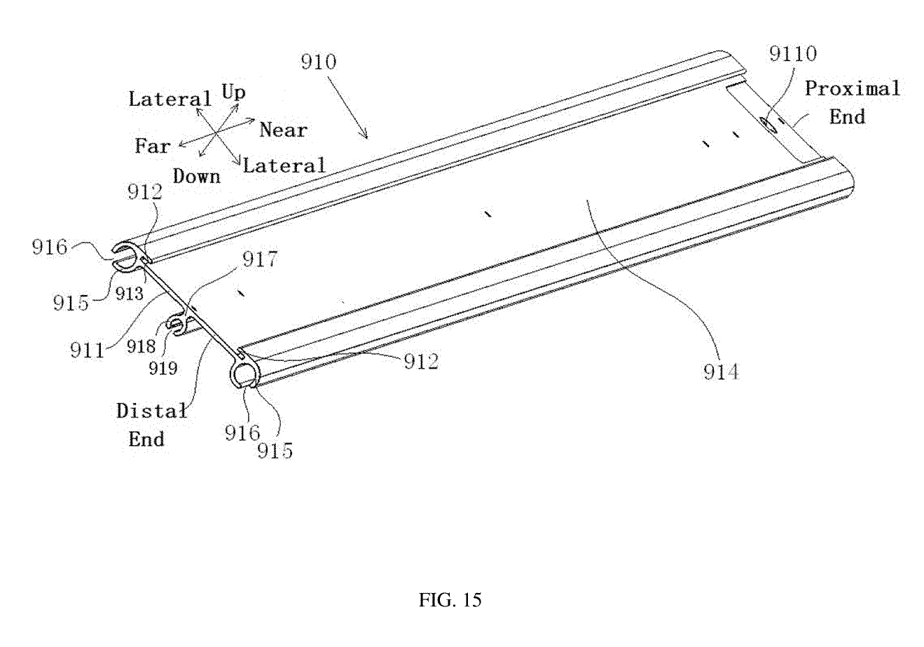

Referring to FIG. 15, the slide rail 910 has a bottom wall 911 and a pair of upper walls 912, with the pair of upper walls extending from two sides of the bottom wall 911 towards each other. A gap 913 exists between each of the two upper walls 912 and the bottom wall 911. The two upper walls 912 do not contact and have a distance therebetween. Thus, the bottom wall 911 and the upper walls 912 define a slide groove 914 which is partially open. The first blanking cap 930 is configured for enclosing a distal end of the slide rail 910, the second blanking cap 940 is configured for enclosing a proximal end of the slide rail 910, and the third blanking cap 950 is configured for enclosing a distant end of the skeleton 920 and limiting a position of the first blanking cap 930. An auxiliary slide rail 915 is provided at each of the two sides of the bottom wall 911 of the slide rail 910. The auxiliary slide rail 915 has a major-arc cross section, and viewing from the perspective view, the auxiliary slide rail 915 has a tubular structure having a first slot 916 with a major-arc cross section. A connecting rib 917 extends downwards from middle position between the two auxiliary slide rails 915 of the bottom wall 911 of the slide rail 910, and a clamping portion 918 is located below the connecting rib 917. The clamping portion 918 also has a major-arc cross section, and viewing from the perspective view, the clamping portion 918 has a tubular structure having a second slot 919 with a major-arc cross section. A communicating hole 9110 is provided in a position of the bottom wall 911 close to a proximal end.

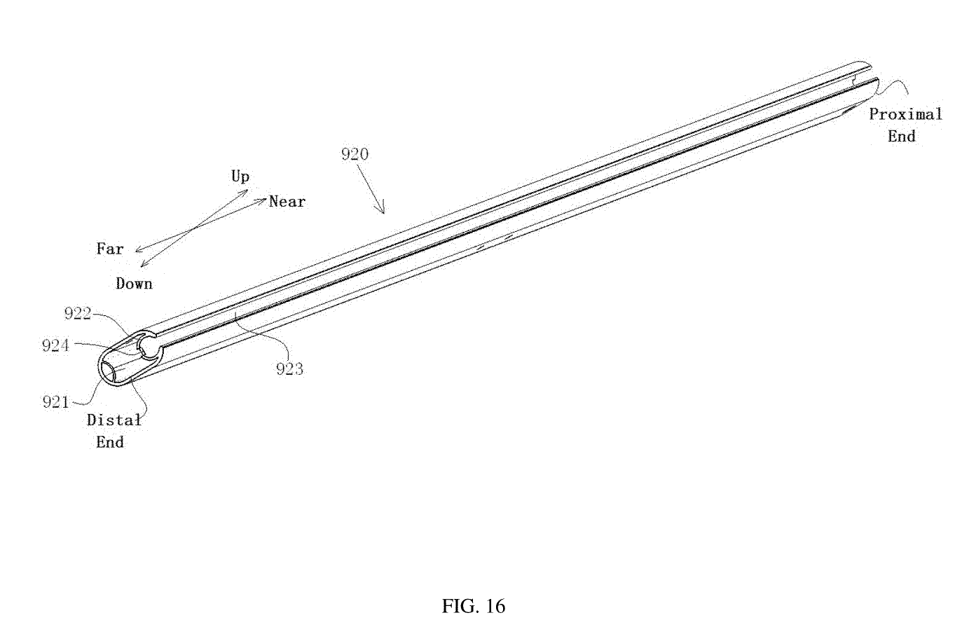

Referring to FIG. 16, the skeleton 920 has a tubular portion 921 and a clamping groove 922, with the clamping groove located at a top of the tubular portion 921. The clamping groove 922 also has a major-arc cross section, and viewing from the perspective view, the clamping groove 922 has a tubular structure having a third slot 923 with a major-arc cross section.

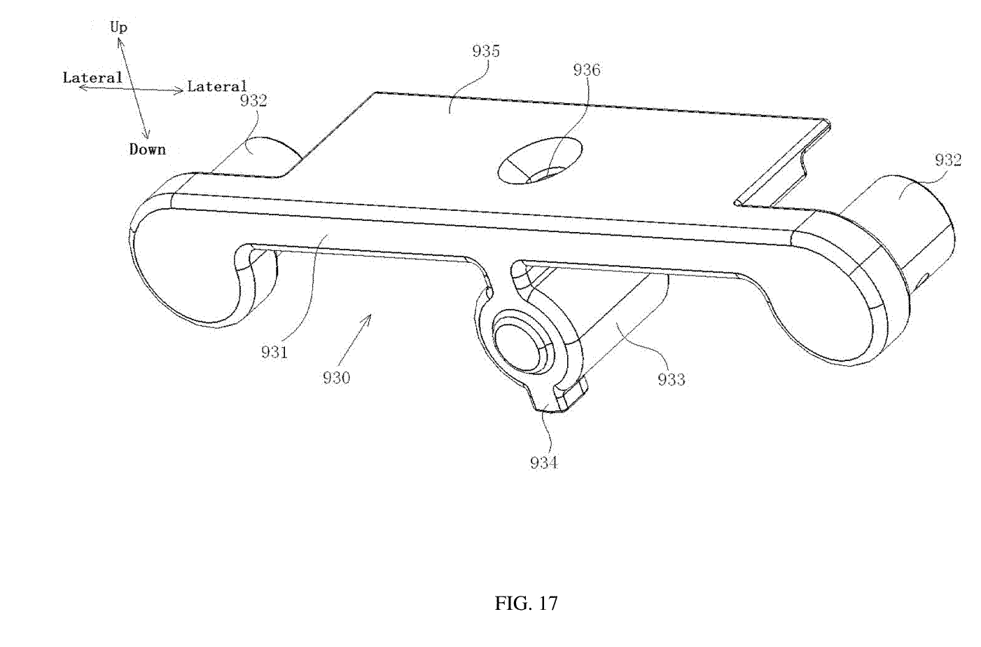

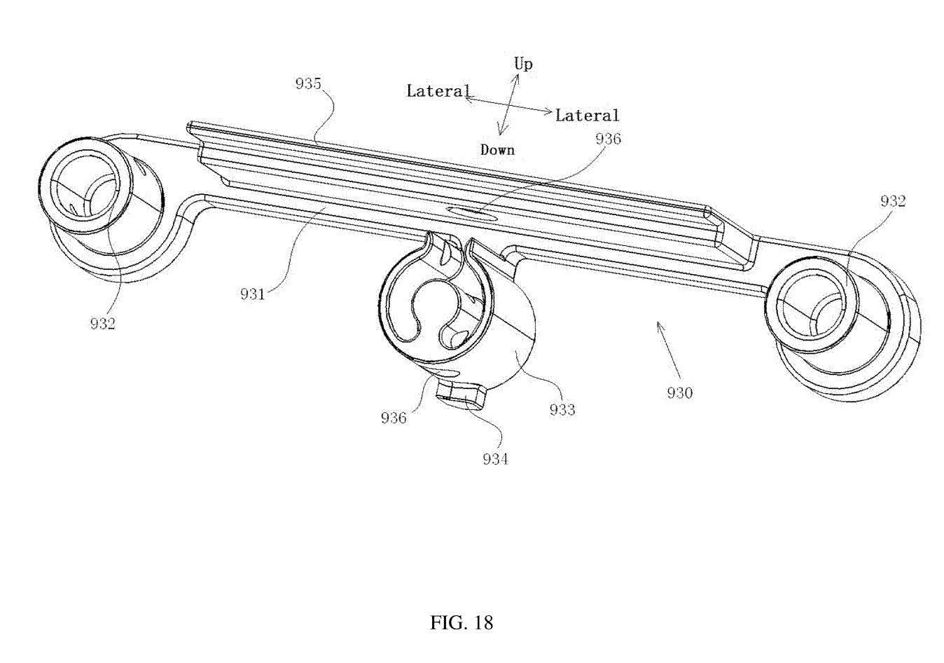

Referring to FIGS. 17 and 18, the first blanking cap 930 has a first arm portion 931 configured for enclosing a distal end of the slide groove 914 in FIG. 15, first tube portions 932 located at two sides of the first arm portion 931 and configured for enclosing distal ends of the auxiliary slide rails 915 in FIG. 15, a second tube portion 933 located below the first arm portion 931 and configured for enclosing the clamping portion 918 in FIG. 15 in the clamping groove 922 in FIG. 16, and a blocking portion 934 located below the second tube portion 933. The first arm portion 931 is further extended out of the first plate portion 935, and the first plate portion 935 is provided with a first bolt hole 936. It can be seen more clearly from FIG. 18 that the first bolt hole 936 penetrates through the first plate portion 935 and the second tube portion 933. Thus, the first plate portion 935 and the second tube portion 933 can be fixed through a bolt.

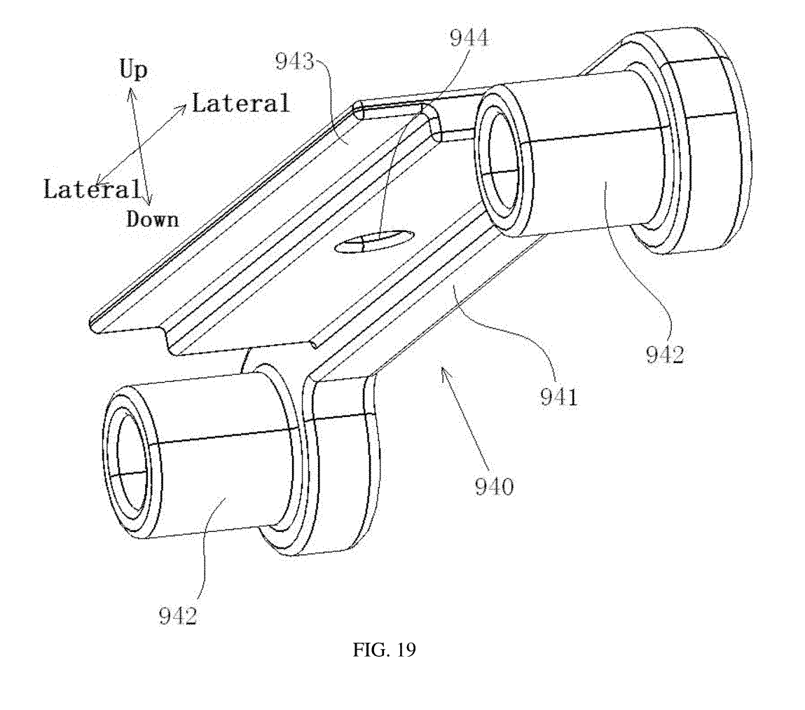

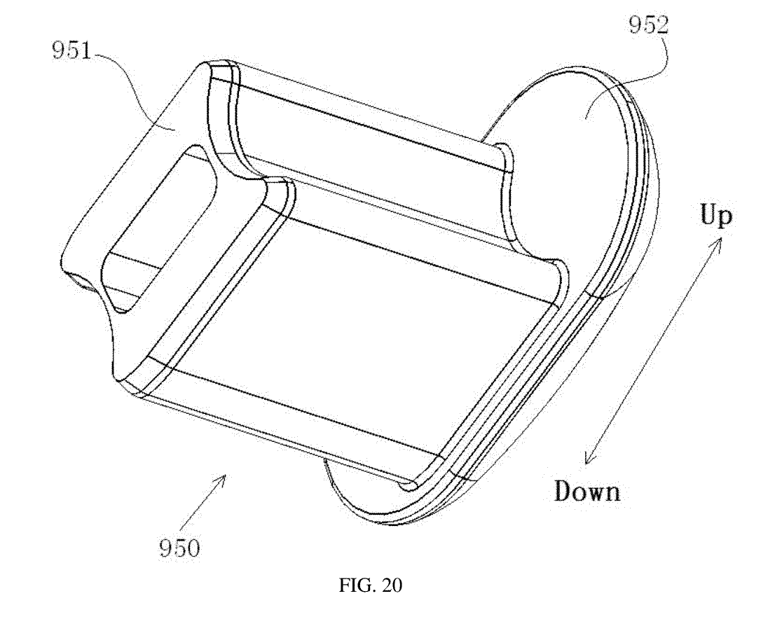

Referring to FIG. 19, the second blanking cap 940 has a second arm portion 941 configured for enclosing a proximal end of the slide groove 914 in FIG. 15, fourth tube portions 942 located at two sides of the second arm portion 941 and configured for enclosing proximal ends of the auxiliary slide rails 915 in FIG. 15, and a second plate portion 943 extending from the second arm portion 941. The second plate portion 943 is provided with a second bolt hole 944. Different from the first blanking cap 930, no structure configured for enclosing the clamping portion 918 and the clamping groove 922 is provided below the second arm portion 941 of the second blanking cap 940.

Referring to FIG. 20, the third blanking cap 950 has a third tube portion 951 configured for enclosing the tubular portion 921 of the skeleton 920, and a stop portion 952 extending upwards from the third tube portion 951. The stop portion 952 can limit a position of the first blanking cap 930. Cooperation of the first blanking cap 930 and the third blanking cap 950 can prevent the first blanking cap 930 from accidentally slipping, and make the assembling and disassembling easy.

The solar cells 101 are supported by the slide grooves 914 on the umbrella ribs 9. Firstly, since the solar cells 101 are mounted inside the slide grooves 914, that is, the slide grooves 914 function to protect the solar cells 101, so that the umbrella cloth 1 of the solar umbrella can be arbitrarily folded without damaging the solar cells 101; secondly, the solar cells 101 can be extracted out just by opening the first blanking cap 930, and if flexible solar cells are used, the solar cells 101 can be extracted from the slide grooves 914 only by means of slight deformation of the flexible solar cells, even without opening the first blanking cap 930, therefore, the detachment of the solar cells 101 is more convenient; and thirdly, since the umbrella cloth 1 does not need to support weight of the solar cells 101, the umbrella cloth 1 is less likely to be damaged.

The slide groove 914 is communicated with the clamping groove 922, the conducting lines of the solar cells 101 can enter the clamping groove 922 of the skeleton 920 from the slide groove 914 of the slide rail 910, thus further enter the umbrella rod 2 and be connected with the storage battery 8. In such manner, the conducting lines of the solar cells 101 can be protected in the whole running process, and the folding of the solar umbrella does not affect the conducting lines, which avoids fracture of the conducting lines.

In combination with FIGS. 13 to 20, a process of assembling the umbrella ribs 9 of the present embodiment is as follows.

The clamping portion 918 of the slide rail 910 is inserted into the clamping groove 922 from an end of the skeleton 920, and the connecting rib 917 extends out from the third slot 923 formed on the clamping groove 922, such that the clamping portion 918 cooperate with the clamping groove 922 to clamp the skeleton 920 and the slide rail 910 together. The clamping portion 918 is communicated with the clamping groove 922 through the second slot 919, and a space formed by the clamping portion and the clamping groove may be configured for receiving conducting lines of the solar cells 101 to be mounted. Then, the distal end of the slide rail 910 is enclosed by the first blanking cap 930, the blocking portion 934 of the first blanking cap 930 is inserted into the notch 924 of the skeleton 920, and a bolt passes through the first bolt hole 936 and then is fastened onto the bottom wall 911. In such case, the first tube portions 932 are inserted into the auxiliary slide rails 915, and the second tube portion 933 is inserted into the clamping groove 922. Then, the proximal end of the slide rail 910 is enclosed by the second blanking cap 940, at which time the fourth tube portions 942 of the second blanking cap 940 are inserted into the auxiliary slide rails 915 of the slide rail 910, and a bolt passes through the second bolt hole 944 and then is fastened onto the bottom wall 911. Subsequently, the third tube portion 951 of the third blanking cap 950 is inserted into the tubular portion 921 of the skeleton 920, so as to enclose the distal end of the skeleton 920, and the stop portion 952 of the third blanking cap 950 cooperates with the blocking portion 934 to limit a position of the first blanking cap 930, in this way, after the third blanking cap 950 is fastened onto the skeleton 920 through the manners such as a bolt, a rivet and interference-fit, the first blanking cap 930 and the slide rail 910 can be prevented from sliding out of the skeleton 920.

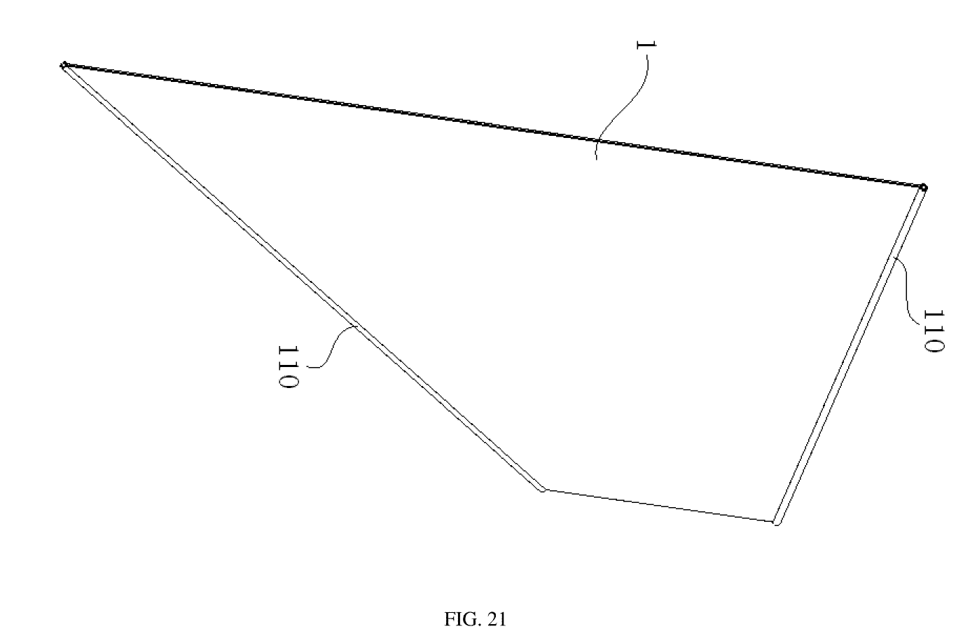

Referring to FIG. 21 and in combination with FIG. 11 and FIG. 12, the umbrella cloth 1 is provided in plurality pieces, the solar umbrella further includes support rods 110 located at two sides of the umbrella cloth 1, and the support rods 110 are connected to two sides of the umbrella cloth 1, so as to serve a supporting function to the umbrella cloth 1.

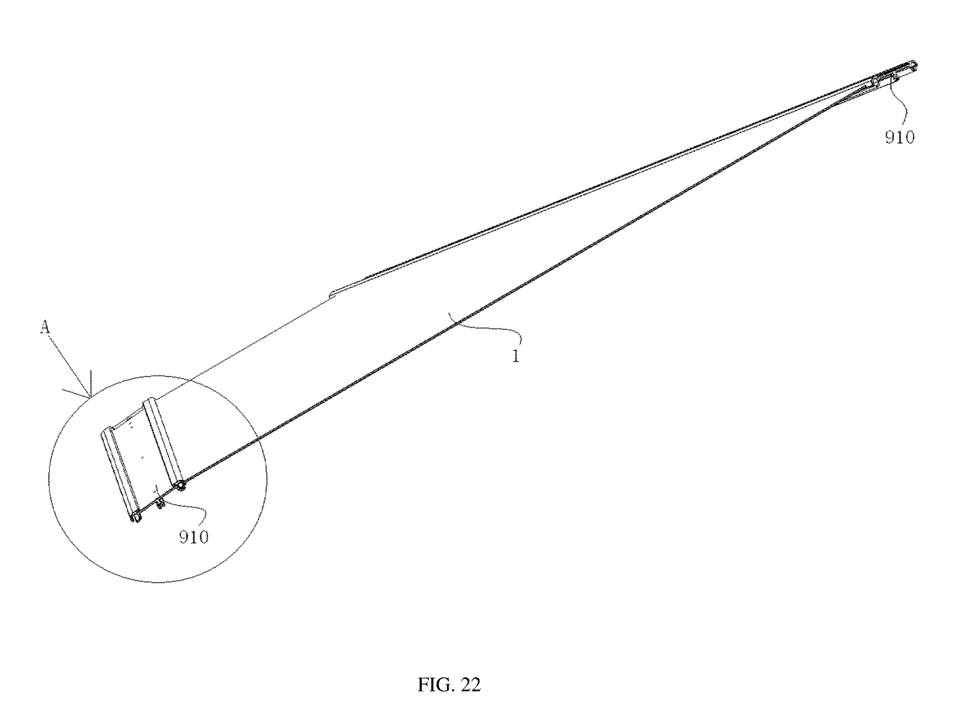

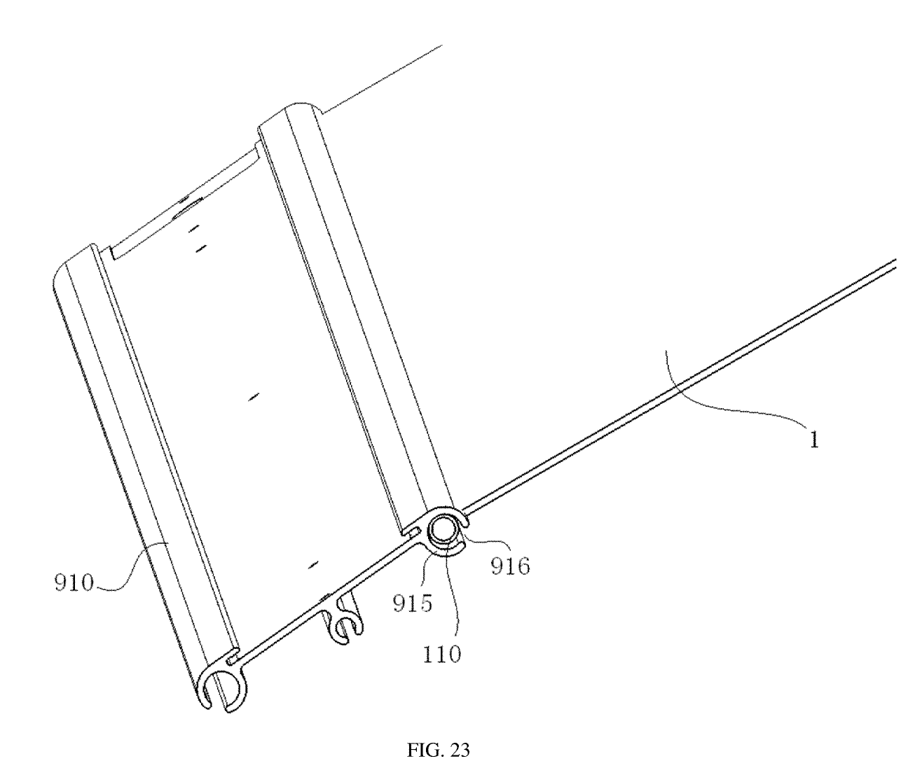

Referring to FIGS. 22 and 23, two support rods 110 of one piece of umbrella cloth 1 are respectively located inside the auxiliary slide rails 915 of the slide rails 910 of two neighboring umbrella ribs 9. The umbrella cloth 1 extends out from the first slot 916 of the auxiliary slide rail 915. Specifically, The first tube portions 932 of the first blanking cap 930 and the fourth tube portions 942 of the second blanking cap 940 enclose the support rods 110 inside the auxiliary slide rails 915, and the first slot 916 of the auxiliary slide rail 915 allows the umbrella cloth 1 to extend therefrom, so as to realize the folding closing or opening of the solar umbrella. When the umbrella cloth 1 needs to be replaced, the first blanking cap 930 is opened, then the support rods 110 of the umbrella cloth 1 can be extracted from the auxiliary slide rails 915, such that it is more convenient to replace the umbrella cloth 1, which causes the requirements of maintenance, shape change, and so on of the umbrella to be satisfied. Therefore, it is beneficial for the umbrella cloth 1 to be in separated structures. Both of the first blanking cap 930 and the second blanking cap 940 have the function of enclosing the slide groove 914 and the auxiliary slide rails 915, and meanwhile can protect the solar cells 101 and the support rods 110 of the umbrella cloth 1.

With the cooperation of the auxiliary slide rails 915 with the support rods 110 at the two sides of the umbrella cloth 1, the umbrella cloth 1 can be extracted out when the first blanking cap 930 is opened, such that it is more convenient to replace the umbrella cloth 1, satisfying the requirements of maintenance, shape change, and so on of the umbrella.

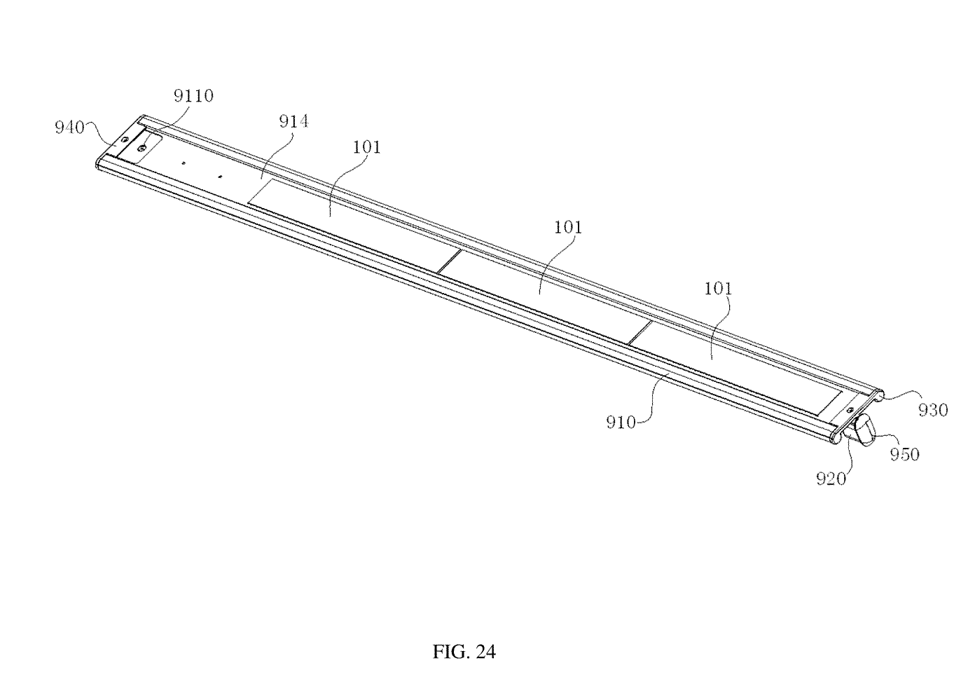

Referring to FIG. 24, the solar cells 101 are limited, by the first blanking cap 930 and the second blanking cap 940, inside the slide groove 914, and are in sliding fit with the slide groove 914. Edges of the solar cells 101 are stuck at the gaps 913, without pasting or stitching. Supporting the solar cells 101 with the slide grooves 914 on the umbrella ribs 9 has following advantages: firstly, the umbrella cloth 1 of the solar umbrella can be arbitrarily folded without damaging the solar cells 101; secondly, when a solar cell 101 needs to be replaced, the whole slide rail 910 and the solar cells 101 thereon can be replaced on the whole by opening the third blanking cap 950, or the first blanking cap 930 is opened to extract the solar cell 101 to merely replace the solar cell 101. If flexible solar cells are used, the solar cells 101 can be extracted from the slide groove 914 only with the aid of slight deformation of the flexible solar cells, even without opening the first blanking cap 930 and the third blanking cap 950, therefore, the detachment is more convenient; thirdly, since the umbrella cloth 1 does not need to support weight of the solar cells 101, the umbrella cloth 1 is less likely to be damaged. The slide groove 914 is communicated with the clamping groove 922 through the communicating hole 9110, meanwhile, the second blanking cap 940 does not enclose the clamping portion 918 or the clamping groove 922 of the slide rail 910. Therefore, the conducting lines of the solar cells 101 can enter the clamping groove 922 of the skeleton 920 through the communicating hole 9110, and further enter the umbrella rod 2 and be connected with the storage battery 8 inside the umbrella rod 2. In a whole running process of the conducting lines of the solar cells 101, the conducting lines can be protected by the skeleton 920, the line concentration device 5 and the umbrella rod 2, and the folding of the solar umbrella does not affect the conducting lines, which avoids fracture of the conducting lines. In practical application, a communicating hole 9110 may also be provided in the second blanking cap 940, so as to enable the slide groove 914 to be communicated with the clamping groove 922.

Using separated structures for the slide rail 910 and the skeleton 920 and assembling them in a clamping manner have following advantages: after the third blanking cap 950 is opened, the slide rail 910 can be extracted out just by pulling the slide rail 910 outwards, which facilitates the replacement and maintenance of the slide rail 910, and satisfies different dimension requirements of the solar cells 101. As mentioned above, the slide rail 910 and the skeleton 920 can also be in a one-piece structure, which simplifies assembling requirements, but will bring shaping difficulty for molding of the umbrella ribs 9.

Referring to FIG. 25, a control circuit of the solar umbrella includes an MCU 1005 (main control unit), an MPPT (maximum power point tracing) controller 1004 and so on. The MCU 1005 is connected with the storage battery 8 through the MPPT controller 1004. Power-on/power-off of the USB interface 604, the LED lamp 901, the motor 1003 and so on are controlled by the MCU 1005. The touch panel 1001 mentioned above is connected with the MCU 1005 so as to realize sending of a control signal, or may send a control signal to the MCU 1005 in a bluetooth manner, that is to say, a built-in bluetooth module 1002 is connected with the MCU 1005. Meanwhile, the stretch and retraction of the umbrella may be realized through corotation or contrarotation of the motor 1003, wherein the umbrella stretches upon the corotation of the motor, and the umbrella retracts upon the contrarotation of the motor. The motor 1003 is controlled by a PID algorithm, so as to realize accurate power-on and power-off of the motor 1003. In other words, the touch panel 1001 is electrically connected with the MCU 1005, the bluetooth module 1002 is electrically connected with the MCU 1005, the MPPT controller 1004 is electrically connected with each of the MCU 1005 and the storage battery 8, and the USB interface 604, the LED lamps 901, and the motor 1003 are all electrically connected with the MCU 1005. Meanwhile, the motor 1003 and the MCU 1005 further have a feedback circuit therebetween, and the MCU 1005 controls the motor 1003 through current feedback.

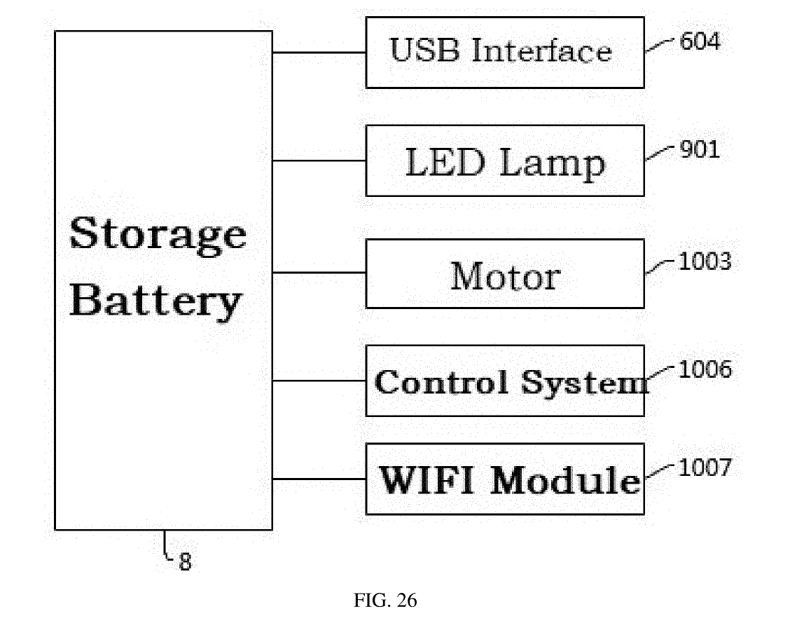

Referring to FIG. 26, the storage battery 8 serves as a power supply for the USB interface 604, the LED lamp 901, the motor 1003, the control system 1006 and WIFI module 1007, and the pressure of the storage battery is regulated by a DC/DC converter.

Specifically, the storage battery 8 supplies power to the USB interface 604 in a DC/DC (5V) manner, the storage battery 8 supplies power to the LED lamps 901 in a step-down constant current manner, the storage battery 8 supplies power to the control system 1006 in a DC/DC (3.3V) manner, and the storage battery 8 supplies power to the WIFI module 1007 in a DC/DC (5V) manner.

It should be indicated that the control system 1006 includes the touch panel 1001, the bluetooth module 1002, the MCU 1005, the MPPT controller 1004 mentioned above and so on.

Referring to FIGS. 1-10, the present embodiment further provides a solar umbrella. The solar umbrella includes solar cells 101 packaged on umbrella cloth 1; umbrella ribs 9 configured for supporting the umbrella cloth 1; a line concentration device 5 mounted on the umbrella ribs 9. The line concentration device 5 has sockets 505, and the solar cells 101 are connected to the sockets 505 of the line concentration device 5.

Specifically, the solar umbrella includes the umbrella cloth 1, an umbrella rod 2, an umbrella base 3, an auxiliary umbrella 4, and the umbrella ribs 9. The solar cells 101 are packaged on the umbrella cloth 1, the umbrella cloth 1 is supported by the umbrella ribs 9, the umbrella rod 2 connects the umbrella ribs 9 and the umbrella base 3, the line concentration device 5 is mounted on the umbrella ribs 9, the auxiliary umbrella 4 is disposed above the umbrella cloth 1 and covers the sockets 505. Generally, the number of the sockets 505 is corresponding to the number of the solar cells 101. Of course, it is also feasible for several solar cells 101 to share one socket 505.

Specifically, in combination with FIGS. 3-5, the line concentration device 5 includes a line concentrator fastener 502, a line concentrator 503 and a line concentration device base 504. The line concentration device base 504 is mounted on the umbrella ribs 9, and the line concentration device base 504 is provided thereon with a recess 506. The line concentrator fastener 502 is fastened onto the line concentration device base 504, so as to hold the line concentrator 503 within the recess 506. The sockets 505 are located on the line concentrator 503.

Specifically, the line concentration device base 504 is mounted on the umbrella ribs 9, and the line concentrator 503 is electrically connected with the solar cells 101.

The line concentration device 5 further includes a top cover 501 of the line concentration device. The top cover 501 of the line concentration device is located above the auxiliary umbrella 4 of the solar umbrella and is connected to the line concentrator fastener 502 so as to hold the auxiliary umbrella 4. The auxiliary umbrella 4 is disposed above the umbrella cloth 1 of the solar umbrella and covers the sockets 505.

In combination with FIG. 10, the solar umbrella further includes a storage battery 8, and the storage battery 8 is located inside the umbrella rod 2 of the solar umbrella and connected with the line concentration device 5. The storage battery 8 includes battery cells 801, a fixing plate 802, a battery top cover 804 and a battery base 805. The battery cells 801 are held and fixed by the fixing plate 802 between the battery top cover 804 and the battery base 805. A positioning groove 807 is provided on the battery base 805. A protrusion corresponding to the positioning groove 807 is provided within the umbrella rod 2, and the positioning groove 807 cooperates with the protrusion such that the storage battery 8 slides into the umbrella rod 2.

In combination with FIGS. 11-15, each of the umbrella ribs 9 includes a skeleton 920 and a slide rail 910 mounted on the skeleton 920. The slide rail 910 is provided with a slide groove 914, and the slide groove 914 is configured for receiving the solar cells 101.

Specifically, each of the umbrella ribs 9 further includes a first blanking cap 930, a second blanking cap 940 and a third blanking cap 950, the slide rail 910 has a bottom wall 911 and a pair of upper walls 912, with the pair of upper walls extending from two sides of the bottom wall 911 towards each other with a gap formed between each upper wall and the bottom wall 911. The bottom wall 911 and the upper walls 912 define the slide groove 914 which is partially open. The first blanking cap 930 is configured for enclosing a distal end of the slide rail 910, the second blanking cap 940 is configured for enclosing a proximal end of the slide rail 910, and the third blanking cap 950 is configured for enclosing a distal end of the skeleton 920 and limiting a position of the first blanking cap 930.

An auxiliary slide rail 915 is further provided at each of the two sides of the slide rail 910. The auxiliary slide rail 915 is in shape of a tube on which a first slot 916 is provided, and the first slot has a major arc-shape cross section.

In combination with FIGS. 15 and 16, a connecting rib 917 extends downwards from a middle position of the bottom wall 911 of the slide rail 910, and a clamping portion 918 is located below the connecting rib 917. The clamping portion 918 is in shape of a tube on which a second slot 919 is provided, and the second slot 919 has a major arc-shape cross section. The skeleton 920 has a tubular portion 921 and a clamping groove 922, with the clamping groove located at a top of the tubular portion 921 and having a major arc-shape cross section. The clamping groove 922 has a third slot 923. The clamping portion 918 of the slide rail 910 is located inside the clamping groove 922, and the connecting rib 917 extends out from the third slot 923 formed on the clamping groove 922.

Specifically, the slide groove 914 is communicated with the clamping groove 922, such that the conducting lines of the solar cells 101 located inside the slide groove 914 can enter the clamping groove 922 successfully.

In combination with FIGS. 17-20, the first blanking cap 930 has a first arm portion 931 configured for enclosing the slide groove 914, first tube portions 932 located at two sides of the first arm portion 931 and configured for enclosing the auxiliary slide rails 915, a second tube portion 933 located below the first arm portion 931 and configured for enclosing the clamping portion 918, and a blocking portion 934 located below the second tube portion 933. The third blanking cap 950 has a third tube portion 951 configured for enclosing the tubular portion 921 and a stop portion 952 extending upwards from the third tube portion 951.

The first blanking cap 930 and the second blanking cap 940 limit positions of the solar cells 101 within the slide groove 914, and the solar cells 101 are in sliding cooperation with the slide groove 914.

In combination with FIG. 21, specifically, the solar umbrella further includes support rods 110 located at two sides of the umbrella cloth 1 of the solar umbrella, the support rods 110 are located inside the auxiliary slide rail 915 of the umbrella ribs 9, and the umbrella cloth 1 extends out from the first slot 916 of the auxiliary slide rail 915.

Referring to FIGS. 11 and 12, the present embodiment further provides another solar umbrella. The solar umbrella includes umbrella ribs 9 and solar cells 101. Referring to FIGS. 13-15, each of the umbrella ribs 9 includes a skeleton 920 and a slide rail 910 mounted on the skeleton 920, the slide rail 910 is provided with a slide groove 914, and the slide groove 914 is configured for receiving the solar cells 101.

It should be indicated that the slide groove 914 may be open at two ends, and enclosed by other structures. The slide groove may also be open at one end and closed at the other end, with the open end being enclosed by other structures. Alternatively, the slide groove 914 is enclosed at two ends, and when the solar cells 101 are to be mounted, the flexible solar cells 101 can be directly clamped into the slide groove 914, or the flexible or rigid solar cells 101 are put in after one end of the slide groove 914 is opened, and the open end is enclosed, so as to complete the packaging of the solar cells 101.

In FIGS. 13-15, umbrella rib 9 further includes a first blanking cap 930, a second blanking cap 940 and a third blanking cap 950. The slide groove 914 is open at the distal end and the proximal end of the slide rail 910, the first blanking cap 930 is configured for enclosing the distal end of the slide rail 910, the second blanking cap 940 is configured for enclosing the proximal end of the slide rail 910, and the third blanking cap 950 is configured for enclosing a distal end of the skeleton 920 and limiting a position of the first blanking cap 930.

In the present embodiment, the first blanking cap 930 and the second blanking cap 940 are fastened onto the slide rail 910 through a bolt, and the third blanking cap 950 is fastened onto the skeleton 920 through a bolt. Of course, the mounting and fixation between two parts may also be realized by means of a rivet, interference-fit, clamping cooperation and bonding.

Referring to FIG. 24, the solar cells 101 are limited in position by the first blanking cap 930 and the second blanking cap 940 inside the slide groove 914 and are in sliding cooperation with the slide groove 914. In FIG. 24, a plurality of solar cells 101 are received side by side inside the slide groove 914. The probability of damaging the solar cells 101 can be reduced by virtue of such positional limiting effect.

It should be indicated that the first blanking cap 930 and the third blanking cap 950 may be in a one-piece structure, and may also be in separated structures. The slide rail 910 and the skeleton 920 may be in a one-piece structure, and may also be in separated structures.

Referring to FIG. 15 and in combination with FIGS. 21-23, an auxiliary slide rail 915 is further provided at each of the two sides of the slide rail 910. The auxiliary slide rail 915 has a tubular structure having a first slot 916, and the first slot 916 has a major arc-shape cross section. The solar umbrella further includes umbrella cloth 1 and support rods 110 located at two sides of the umbrella cloth 1. The umbrella cloth 1 is supported by the umbrella ribs 9. The umbrella cloth 1 is provided in plurality pieces. Two adjacent support rods 110 are respectively located inside the auxiliary slide rails 915 of two neighboring umbrella ribs 9. The umbrella cloth 1 extends out from the first slots 916 of the auxiliary slide rails 915. In this way, the first slot 916 of the auxiliary slide rail 915 allows the umbrella cloth 1 to extend therefrom, so as to realize the folding closing or opening of the solar umbrella. When the umbrella cloth 1 needs to be replaced, the first blanking cap 930 is opened, so that the support rods 110 of the umbrella cloth 1 can be extracted from the auxiliary slide rails 915. It should be indicated that in specific implementation, the auxiliary slide rails 915 may also be T-shape grooves or dovetail grooves, and the shape of the support rods 110 is adapted to the T-shape grooves or dovetail grooves, then corresponding effects can also be achieved.

Referring to FIGS. 15 and 16, the connecting rib 917 extends downwards from the middle position of the bottom wall 911 of the slide rail 910, and the clamping portion 918 is located below the connecting rib 917. The clamping portion 918 is in shape of a tube on which the second slot 919 is provided, and the second slot 919 has a major arc-shape cross section. The skeleton 920 has the tubular portion 921 and the clamping groove 922, with the clamping groove located at the top of the tubular portion 921 and having a major arc-shape cross section. The clamping groove 922 is in shape of a tube on which a third slot 923 is provided and the third slot 923 has a major arc-shape cross section. The clamping portion 918 of the slide rail 910 is located inside the clamping groove 922, and the connecting rib 917 extends out from the third slot 923 on the clamping groove 922. A space formed by the clamping portion 918 and the clamping groove 922 is configured for receiving the conducting lines of the solar cells 101.

Referring to FIGS. 15 and 16, the slide groove 914 is communicated with the clamping groove 922, such that the conducting lines of the solar cells 101 located inside the slide groove 914 can enter the clamping groove 922 successfully.

Specifically, in FIG. 15, a communicating hole 9110 is provided on the bottom wall 911 of the slide rail 910 close to a proximal end of the slide rail 910, the slide groove 914 is communicated with the clamping groove 922 through the communicating hole 9110, and the communicating hole 9110 is configured in such a way that the conducting lines of the solar cells 101 located inside the slide groove 914 can enter the clamping groove 922 of the skeleton 920 through the communicating hole 9110. Meanwhile, it should be indicated that a hole may also be provided in the second blanking cap 940, so as to enable the slide groove 914 to be communicated with the clamping groove 922.

Referring to FIGS. 17-20, the first blanking cap 930 has a first arm portion 931 configured for enclosing the slide groove 914, first tube portions 932 located at two sides of the first arm portion 931 and configured for enclosing the auxiliary slide rails 915, a second tube portion 933 located below the first arm portion 931 and configured for enclosing the clamping portion 918, and a blocking portion 934 located below the second tube portion 933. The third blanking cap 950 has a third tube portion 951 configured for enclosing the tubular portion 921 and a stop portion 952 extending upwards from the third tube portion 951.

Referring to FIG. 19, the second blanking cap 940 has a second arm portion 941 configured for enclosing the slide groove 914, fourth tube portions 942 located at two sides of the second arm portion 941 and configured for enclosing the auxiliary slide rails 915. The second blanking cap 940 does not enclose the clamping portion 918 and the clamping groove 922.

The distal end of the slide rail 910 is enclosed by the first blanking cap 930, the blocking portion 934 of the first blanking cap 930 is inserted into the notch 924 of the skeleton 920, and a bolt passes through the first bolt hole 936 and then is fastened onto the bottom wall 911. In such case, the first tube portions 932 are inserted into the auxiliary slide rails 915, and the second tube portion 933 is inserted into the clamping groove 922. Then, the proximal end of the slide rail 910 is enclosed by the second blanking cap 940, in which case the fourth tube portions 942 of the second blanking cap 940 are inserted into the auxiliary slide rails 915 of the slide rail 910, and a bolt passes through the second bolt hole 944 and then is fastened onto the bottom wall 911. Subsequently, the third tube portion 951 of the third blanking cap 950 is inserted into the tubular portion 921 of the skeleton 920, so as to enclose the distal end of the skeleton 920, such that the stop portion 952 of the third blanking cap 950 cooperates with the blocking portion 934 to limit a position of the first blanking cap 930.

The above-mentioned are merely for embodiments of the present disclosure, but the scope of protection of the present disclosure is not limited thereto. Any alterations or substitutions that may easily envisaged by a person familiar to the art within the technical scope disclosed in the present disclosure, should be covered within the scope of protection of the present disclosure. Therefore, the scope of protection of the present disclosure should be based on the scope of protection of the claims.

What is claimed is:

1. A solar umbrella, comprising:
solar cells packaged on umbrella cloth;
umbrella ribs configured for supporting the umbrella cloth;
a line concentration device mounted on the umbrella ribs, the line concentration device has sockets, the solar cells are connected to the sockets of the line concentration device.

2. The solar umbrella of claim 1, wherein the line concentration device comprises a line concentrator fastener, a line concentrator and a line concentration device base, the line concentration device base is mounted on the umbrella ribs, the line concentration device base is provided thereon with a recess, the line concentrator fastener is fastened onto the line concentration device base so as to hold the line concentrator within the recess, and the sockets are located on the line concentrator.

3. The solar umbrella of claim 2, wherein the line concentration device further comprises a top cover of the line concentration device, and the top cover of the line concentration device is located above an auxiliary umbrella of the solar umbrella and connected with the line concentrator fastener so as to clamp the auxiliary umbrella, and the auxiliary umbrella is disposed above the umbrella cloth of the solar umbrella and covers the sockets.

4. The solar umbrella of claim 1, wherein the solar umbrella further comprises a storage battery, the storage battery is located inside an umbrella rod of the solar umbrella and connected with the line concentration device, the storage battery comprises a battery cell, a fixing plate, a battery top cover and a battery base, the battery cell is clamped by the fixing plate and fixed between the battery top cover and the battery base, the battery base is provided with a positioning groove, a protrusion corresponding to the positioning groove is provided within the umbrella rod, and the positioning groove cooperates with the protrusion to enable the storage battery to slide into the umbrella rod.

5. The solar umbrella of claim 1, wherein each of the umbrella ribs comprises a skeleton and a slide rail mounted on the skeleton, the slide rail is provided with a slide groove and the slide groove is configured for receiving the respective solar cell.

6. The solar umbrella of claim 5, wherein each of the umbrella ribs further comprises a first blanking cap, a second blanking cap and a third blanking cap, the slide rail has a bottom wall and a pair of upper walls, with the pair of upper walls extending from two sides of the bottom wall towards each other and with a gap formed between each upper wall and the bottom wall, the bottom wall and the upper walls define the slide groove which is partially open, the first blanking cap is configured for enclosing a distal end of the slide rail, the second blanking cap is configured for enclosing a proximal end of the slide rail, and the third blanking cap is configured for enclosing a distal end of the skeleton and limiting a position of the first blanking cap.

7. The solar umbrella of claim 6, wherein an auxiliary slide rail is provided at each of the two sides of the slide rail, and the auxiliary slide rail is in shape of a tube on which a first slot having a major arc-shaped cross section is provided.

8. The solar umbrella of claim 7, wherein the solar umbrella further comprises support rods located at two sides of the umbrella cloth of the solar umbrella, the support rods are respectively located inside the auxiliary slide rails of the umbrella ribs, and the umbrella cloth extends out from the first slots of the auxiliary slide rails.

9. The solar umbrella of claim 7, wherein a connecting rib extends downwards from a middle position of the bottom wall of the slide rail and a clamping portion is located below the connecting rib, the clamping portion is in shape of a tube on which a second slot having a major arc-shaped cross section is provided, the skeleton has a tubular portion and a clamping groove, with the clamping groove located at a top of the tubular portion and having a major arc-shaped cross section, the clamping groove has a third slot, and the clamping portion of the slide rail is located inside the clamping groove and the connecting rib extends out from the third slot formed on the clamping groove.

10. The solar umbrella of claim 9, wherein the slide groove is communicated with the clamping groove.

11. The solar umbrella of claim 9, wherein the first blanking cap has a first arm portion, first tube portions, a second tube portion and a blocking portion, with the first arm portion configured for enclosing the slide groove, the first tube portions located at two sides of the first arm portion and configured for enclosing the auxiliary slide rails, the second tube portion located below the first arm portion and configured for enclosing the clamping portion, and the blocking portion located below the second tube portion, and the third blanking cap has a third tube portion configured for enclosing the tubular portion and a stop portion extending upwards from the third tube portion.

12. The solar umbrella of claim 6, wherein the first blanking cap and the second blanking cap limit each of the solar cells inside the slide groove and the solar cells are in sliding fit with the slide groove.

13. A solar umbrella, comprising umbrella ribs and solar cells, wherein each of the umbrella ribs comprises a skeleton and a slide rail mounted on the skeleton, the slide rail is provided with a slide groove, and the slide grooves of the umbrella ribs are configured for receiving the solar cells.

14. The solar umbrella of claim 13, wherein each of the umbrella ribs further comprises a first blanking cap, a second blanking cap and a third blanking cap, the slide groove of the slide rail is open at a distal end and a proximal end of the slide rail, the first blanking cap is configured for enclosing the distal end of the slide rail, the second blanking cap is configured for enclosing the proximal end of the slide rail, and the third blanking cap is configured for enclosing a distal end of the skeleton and limiting a position of the first blanking cap.

15. The solar umbrella of claim 14, wherein an auxiliary slide rail is further provided at each of the two sides of the slide rail, and the auxiliary slide rail is in shape of a tube on which a first slot having a major arc-shape cross section is provided.

16. The solar umbrella of claim 15, wherein the solar umbrella further comprises umbrella cloth and support rods located at two sides of the umbrella cloth, the umbrella cloth is supported by the umbrella ribs, the umbrella cloth is provided in plurality pieces, two adjacent support rods are respectively located inside the auxiliary slide rails of two adjacent umbrella ribs, and the umbrella cloth extends out from the first slots of the auxiliary slide rails.

17. The solar umbrella of claim 16, wherein a connecting rib extends downwards from a middle position of a bottom wall of the slide rail and a clamping portion is located below the connecting rib, the clamping portion is in shape of a tube on which a second slot having a major arc-shape cross section is provided, the skeleton has a tubular portion and a clamping groove, with the clamping groove located at the top of the tubular portion and having a major arc-shape cross section, the clamping groove is in shape of a tube on which a third slot having a major arc-shape cross section is provided, the clamping portion of the slide rail is located inside the clamping groove and the connecting rib extends out from the third slot formed on the clamping groove, and a space formed by the clamping portion and the clamping groove is configured for receiving conducting lines of the solar cells.

18. The solar umbrella of claim 17, wherein the slide groove is communicated with the clamping groove.

19. The solar umbrella of claim 18, wherein a communicating hole is provided in a bottom wall of the slide rail and close to the proximal end of the slide rail, the slide groove is communicated with the clamping groove through the communicating hole, and the communication hole is configured in such a way that the conducting lines of the solar cells inside the slide groove can enter the clamping groove of the skeleton through the communicating hole.

20. The solar umbrella of claim 17, wherein the first blanking cap has a first arm portion, first tube portions, a second tube portion and a blocking portion, with the first arm portion configured for enclosing the slide groove, the first tube portions located at two sides of the first arm portion and configured for enclosing the auxiliary slide rails, the second tube portion located below the first arm portion and configured for enclosing the clamping portion, and a blocking portion located below the second tube portion, and the third blanking cap has a third tube portion configured for enclosing the tubular portion and a stop portion extending upwards from the third tube portion.
